(19) United States
(12) Patent Application Publication
(10) Pub. No.: US 2005/0105383 A1
(43) Pub. Date: May 19, 2005

(54) Handbarrow

(76) Inventor: Eugene Norman Beaudry, Essex Junction, VT (US)

Correspondence Address: JAMES MARC LEAS, 37 BUTLER DRIVE, S. BURLINGTON, VT, 05403, US

(21) Appl. No.: 10/990,573

(22) Filed: Nov. 17, 2004

Related U.S. Application Data
(60) Provisional application No. 60/520,704, filed on Nov. 17, 2003.

(51) Int. Cl. B01F 13/00

(52) U.S. Cl. 366/130

(57) ABSTRACT

A tool for carrying, mixing or dispensing a material is disclosed. The tool includes a bottom surface, a back surface, and side walls. The tool has an open front and an open top. A handle extends from said back surface toward the open front. No bracing extends from the handle to bottom surface.

### RELATED APPLICATIONS

This application claims priority of Provisional Patent Application 60/520,704, filed Nov. 17, 2003, incorporated herein by reference.

### FIELD

This patent application generally relates to a device for mixing and carrying material.

### SUMMARY

A method of mixing materials, is disclosed, including the steps of providing a mixing tool that includes a bottom surface, a back surface, and a handle. The tool has an open front and an open top. The handle extends through the back surface and over the bottom surface. The method includes tilting the mixing tool so material is contained therein, loading the materials to be mixed on the bottom surface, mixing the materials, wherein mixing can be accomplished from the open front facilitating access under the materials, and carrying the mixing tool with the materials.

Another embodiment is a tool for carrying, mixing or dispensing a material. The tool includes a bottom surface, a back surface, and side walls. The tool has an open front and an open top. A handle extends from said back surface toward the open front. No bracing extends from the handle to bottom surface.

### BRIEF DESCRIPTION OF DRAWINGS

FIGS. 1-4 are three dimensional view of an embodiment of the handbarrow;

FIG. 5 is a three-dimensional view of an embodiment having a wheel;

FIG. 6 is a three-dimensional view of an embodiment having an extension handle;

FIG. 7 is a three-dimensional view of an embodiment in use; and

FIG. 8 is another three-dimensional view of an embodiment in use.

### DETAILED DESCRIPTION

The Handbarrow is a device for carrying, transferring, and applying various materials.

In one embodiment the Handbarrow is 18 inches wide along the trim piece of FIG. 5 by 24 inches in length. The handbarrow can vary in dimensions. In other embodiments its dimensions are in the range from about 12×18 inches to about 24×36 inches. Back B, handle, C and rear truss support D can be fabricated of wood, plastic, or a metal, such as steel or aluminum. The entire structure can be formed in one integral piece of molded plastic or it can be fabricated in separate parts.

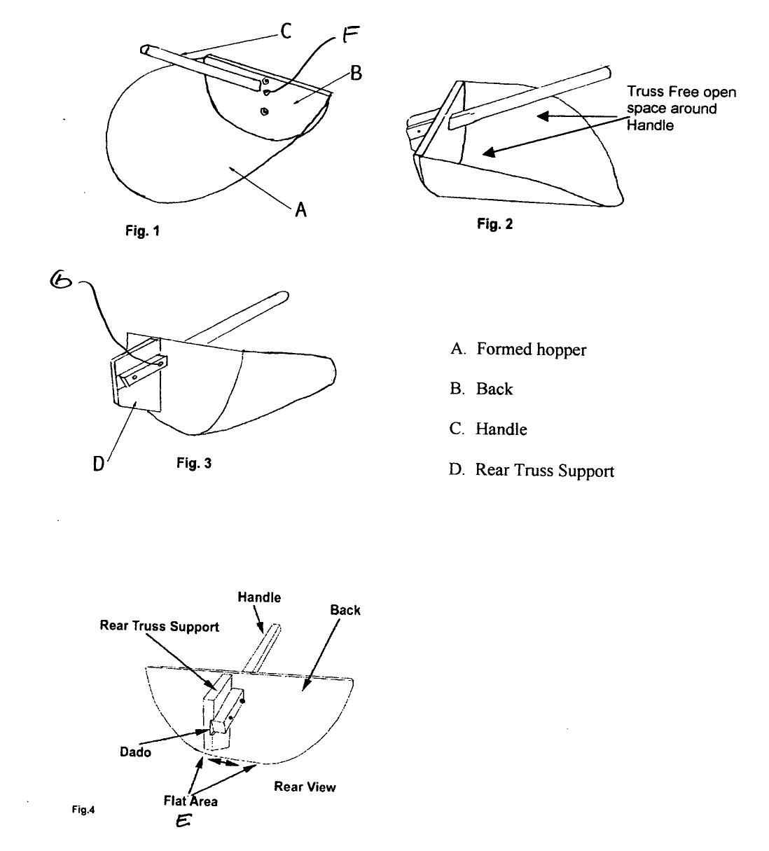

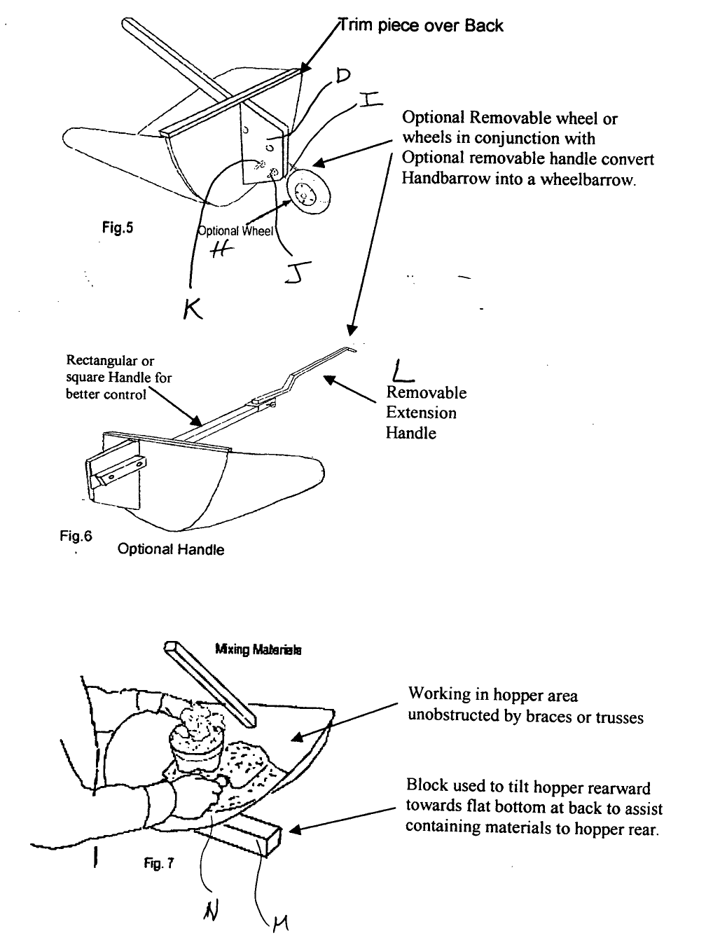

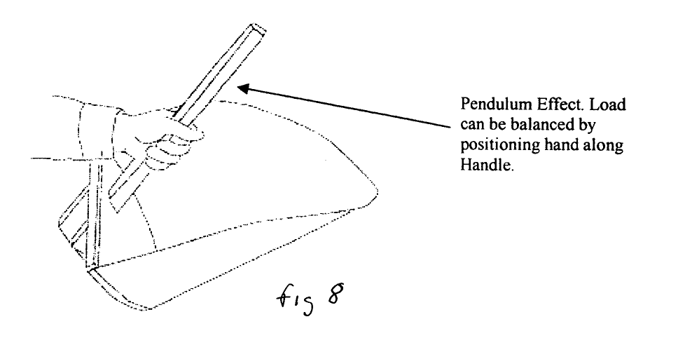

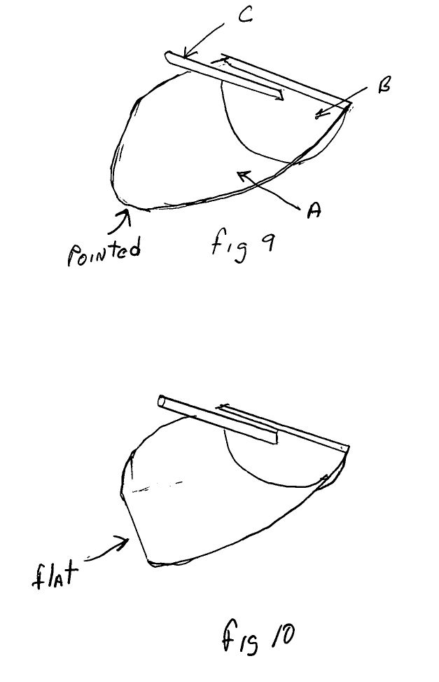

The Handbarrow consists of four parts, as shown in FIGS. 1-4. Formed hopper A fits securely to back B. As the hopper proceeds in a direction away from the back it is formed to have a flair causing a larger radius than the back. Hopper A can be fabricated of a metal, such as steel or aluminum, or a plastic, such as fiberglass or HTPE. Hopper A can have various shapes. For example, hopper A can have a narrower front to facilitate filling sandbags or concrete form tubes, as shown in FIG. 9.

Back B has a flat bottom portion E to allow Handbarrow to sit level without rocking when the Handbarrow is placed on a horizontal surface. Back B supports and maintains the curvature of hopper A, which extends from back B.

Handle C is set at an angle of about 20 to 22 degrees with respect to horizontal when flat area E is down. This angle can vary from about 15 degrees to about 30 degrees. Larger angles, such as 40 degrees can also be used. Handle C fits through back B and connects to Rear Truss Support D. Rear truss support D connects to back B with screws F. In this example of construction rear truss support D is dadoed out to accept handle C as it extends through back B so as to better transfer weight from handle C to rear truss support D instead of relying on bolts G for that purpose.

The Handbarrow can be fitted with wheel H, or with two or more wheels, which may be connected to rear truss support D with metal bar I, bolts J, and wing nuts K, as shown in FIG. 5.

Handle C of the Handbarrow can also be fitted with extension handle L, as shown in FIG. 6. This is particularly advantageous when wheel H is attached. With optional extension handle L and optional wheel H connected, the Handbarrow converts to a wheelbarrow, as shown in FIGS. 5-6.

The Handbarrow makes easier carrying, dispensing and applying various slurry materials, such as cement or stucco. It also makes easier carrying wood, dry granular materials, such as sand, food grains, and fertilizer. It is also good for carrying liquids of various viscosities, such as water.

When a load is placed in hopper A the weight of the load is transferred through back B to truss support D to the handle C. The angular assent of handle C from back B away from hopper A allows the load to be better balanced. The person holding the handle can adjust location of his or her hand along handle C to obtain an optimum balance of load and hand position on handle C. Handle C is long enough to provide this balancing, as shown in FIG. 8. Handle C may have a square part, as shown in FIGS. 6-8 with smooth rounded edges through the grip range of the handle to allow the operator=s hand to twist it and better transfer torsion to back B via truss support D. The operator can balance back B on his or her knee on either side of truss support D to manipulate the handbarrow to assist positioning for applying and dispensing load materials. Handle C is also long enough to provide stability when the operator hands the handbarrow to another operator. Handle C is particularly suited for transferring the handbarrow between operators on different levels of elevation, such as staging or scaffolding.

Rear truss support D transfers the load from back B to handle C outside of hopper A, providing clear open space in hopper A under handle C. This allows free movement in hopper A for hands, tools or utensils for mixing material in hopper A or for using hopper A to apply materials to another surface.

Thus, hopper A is useful both for holding materials and for applying masonry materials such as stuccos and surface applied slurries to other masonry materials such as bricks, blocks or backers. In one way of operation, hopper C is held right up against and touching the backer that is to be surfaced with slurry material in hopper C, and the slurry material is transferred directly to the backer using a trowel utensil.

In another way of operation, hopper A is used for mixing various materials, such as a liquid and a granular material to make cement, plaster, drywall compound, or a mixture of potting soils, as shown in FIG. 7. The open unobstructed space between hopper A and handle C allows for adding materials from either side of handle C. Using block of material M under forward part N of hopper A, the handbarrow will be stable tilting back on flat bottom portion E of Back B. Hopper A will be able to contain more liquid slurry while mixing in this tilted back position with block M. Hopper A widens as it proceeds from Back B to open forward part N of Hopper A. This allows load materials to be carried securely and allows greater access to load material when mixing or delivering load material.

While the disclosed methods and systems have been shown and described in connection with illustrated embodiments, various changes may be made therein without departing from the spirit and scope of the invention as defined in the appended claims.

1. A method of mixing materials, comprising the steps of:
a) providing a mixing tool that includes a bottom surface, a back surface, and a handle, said tool having an open front and an open top, said handle extending through said back surface and over said bottom surface;
b) tilting said mixing tool so material is contained therein;
c) loading the materials to be mixed on said bottom surface;
d) mixing said materials, wherein mixing can be accomplished from said open front facilitating access under the materials; and
e) carrying said mixing tool with said materials.

2. A tool for carrying, mixing or dispensing a material, comprising:
a bottom surface, a back surface, and side walls, wherein said tool has an open front, and an open top; and
a handle extending from said back surface toward said open front wherein no bracing extends from said handle to said side walls or said bottom surface.

3. A tool as described in claim 2, wherein said handle is tilted with respect to said bottom surface.

4. A tool as described in claim 3, wherein said handle is tilted at an angle in the range from 15 to 30 degrees with respect to said bottom surface.

5. A tool as described in claim 4, wherein said handle is tilted at an angle in the range from 20 to 25 degrees with respect to said bottom surface.

6. A tool as described in claim 2, wherein said handle facilitates balancing of the material.

7. A tool as described in claim 2, wherein said handle has a rectangular cross section to facilitate torsion control.

8. A tool as described in claim 2, wherein said tool has a back surface dimension exceeding 12 inches.

9. A tool as described in claim 2, wherein said bottom surface curves to form said sidewalls.

10. A tool as described in claim 2, further comprising a rear truss support, wherein said handle is integrated with said rear truss support.

11. A tool as described in claim 10, wherein said handle is dadod with said rear truss support.

12. A tool as described in claim 2, further comprising wheels.

13. A tool as described in claim 12, further comprising an extension handle for attaching to said handle to facilitate maneuvering said tool with said wheels.

14. A tool as described in claim 1, wherein said sidewalls are integral with said bottom surface.

15. A tool as described in claim 1, wherein said bottom surface, back surface, side walls and handle are all in one integrated structure.

16. A tool as described in claim 1, wherein said bottom surface has a shape for filling at least one from the group including sandbags and concrete form structures.
